(19) United States
(12) Patent Application Publication
(10) Pub. No.: US 2018/0020781 A1
(43) Pub. Date: Jan. 25, 2018

(54) RESILIENT STRAP WITH HOOK AND LOOP FASTENERS

(71) Applicant: Paul MCNEILL, Carnegie (AU)

(72) Inventor: Paul MCNEILL, Carnegie (AU)

(21) Appl. No.: 15/655,774

(22) Filed: Jul. 20, 2017

(30) Foreign Application Priority Data
Jul. 21, 2016 (AU) 2016902878

(51) Int. Cl. A44B 18/00; G09F 17/00

(52) U.S. Cl. CPC A44B 18/0069; G09F 17/00; A44D 2203/00; A44D 2205/00; G09F 2017/0075; E01F 13/028

(57) ABSTRACT

A strap includes an elongate flexible resilient (elastic) base having a plurality of spaced paired attachment sections mounted therealong. Each paired attachment section includes first and second elements, which are adapted to be attachable to each other and are mounted to the base to face away from each other, and on opposite sides of the base. The paired attachment sections include patches of hook and loop fasteners. The patches of hook fasteners are mounted spaced along one side of the base, and the patches of loop fasteners are mounted spaced along the opposite side of the base. The patches are thus ‘back to back’ in each section.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to an elongate resilient strap with spaced hook and loop fasteners mounted thereon. The strap can be used as a tie-down strap or can be modified to function as a warning or information banner.

### 2. Description of Related Art Including Information Disclosed Under 37 CFR 1.97 and 37 CFR 1.98

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a strap comprising
an elongate resilient base,
a plurality of spaced paired attachment sections mounted along the base, the paired attachment sections each comprising first and second fastener elements which are attachable to each other,
   wherein in use the first fastener element of one attachment section is attachable to the second fastener element in another attachment section.

In one embodiment, the first and second fastener elements are mounted to the base to face away from each other, and the first and second fastener elements are mounted on opposite sides of the base.

In another embodiment, the first fastener elements comprise patches of hook fasteners and the second fastener elements comprise patches of loop fasteners.

In another embodiment, the patches of hook fasteners are mounted spaced along one side of the base and the patches of loop fasteners are mounted spaced along the opposite side of the base.

In another embodiment, the patches of hook and loop fasteners are alternatingly mounted spaced along each side of the base.

In another embodiment, the base is made from stretchable elastic material.

In another embodiment, the base is formed as an elongated band.

In another embodiment, the base is formed as an elastic cord.

In another embodiment, the paired attachment sections are spaced evenly along the length of the base.

In another embodiment, the strap comprises an end loop at one end thereof.

In another embodiment, the strap comprises a thumb tab at the other end thereof extending perpendicularly to the base.

In another embodiment, the strap comprises an end loop at both ends thereof.

In another embodiment, the strap comprises a flag at one end thereof.

In another embodiment, each paired attachment section comprises a flag or banner fixed between one of the first and second fastener elements and the base member.

In another embodiment, the first and second fastener elements are magnetic pairs or intermeshing repositionable fasteners.

In another embodiment, the thumb tab comprises the first fastener element or the second fastener element.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIGS. 1 (a) and (b) show schematic views of a section of a strap in accordance with a preferred embodiment of the present invention, and (c) shows a modified version of the strap having an end loop at one end and a thumb tab at the other end.

FIG. 2 (a) shows a schematic view of a section of a modified embodiment of the strap to function as a warning or barricade tape, and (b) is a close-up exploded perspective view of a mounted hook and loop section of the strap.

FIG. 3 shows a schematic view of a section of another modified embodiment of the strap.

FIG. 4 shows a schematic view of one possible use of the strap of FIG. 2.

FIG. 5 shows a schematic view of one possible use of the strap of FIG. 1.

### DETAILED DESCRIPTION OF THE INVENTION

It should be noted in the following description that like or the same reference numerals in different embodiments denote the same or similar features.

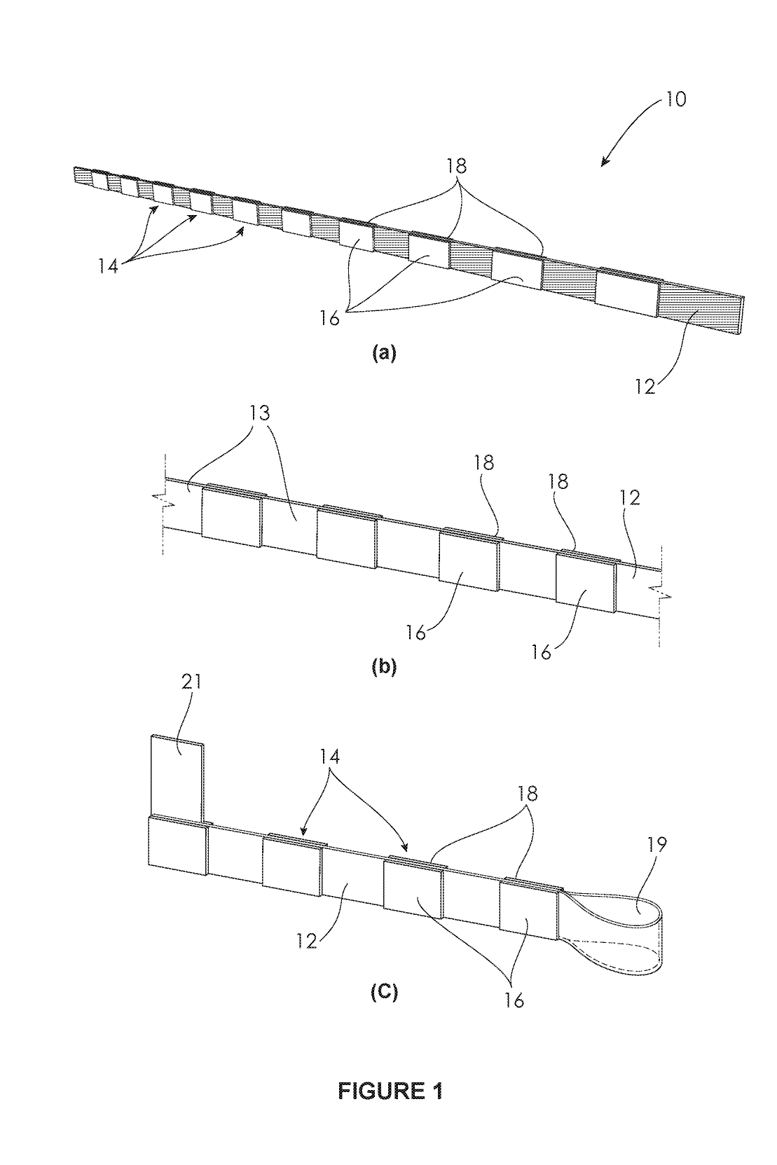

FIG. 1 shows a strap 10 according to a preferred embodiment of the present invention. The strap 10 comprises an elongate flexible resilient (elastic) base 12 having a plurality of spaced paired attachment sections 14 mounted therealong.

The paired attachment sections 14 each comprise first and second elements 16 and 18 which are adapted to be attachable to each other and are mounted to the base 12 to face away from each other, and on opposite sides of the base 12. In the preferred embodiment, the paired attachment sections 14 comprise patches of hook and loop (e.g. VELCRO™) fasteners, for example patches of hook fasteners 16 and patches of loop fasteners 18.

The patches of hook fasteners 16 are mounted spaced along one side of the base 12, and the patches of loop fasteners 18 are mounted spaced along the opposite side of the base 12. The patches 16 and 18 are thus ‘back to back’ in each section 14.

As the paired fasteners 16 and 18 in each section 14 face away from each other, they are not attachable to each other. Instead, in use, the first fastener element 16 in one section 14 is attachable to the second fastener element 18 in another section 14.

The base 12 can be made from any desired stretchable elastic material. The material in the preferred embodiment is formed as an elongated band, made from rubber, knitted elastic, neoprene, or any other suitable elastic band material. The base 12 can alternatively be made from elastic cord such as bungee cord. The base 12 can be made in any width, with varying width straps 10 being usable for different applications. In the embodiment shown, the base 12 for example can be 2.5 cm to 5 cm wide. The base 12 can be made in any length.

The paired attachment sections 14 comprise patches of hook and loop fasteners 16 and 18. In the embodiment, the patches are as wide as the base 12 and the patches 16 and 18 in each pair are of similar length. The paired attachment sections 14 are spaced evenly along the length of the base 12, at a distance of about twice the length of the patches.

The elastic base 12 is stretchable and the sections 13 between the paired attachment sections 14 can stretch unimpeded. This allows the strap 10 to be used for various tie-down or wrap applications as the base 12 will be able to provide a tensioned wrap as needed with the paired attachment sections 14 providing the locking attachment without scratching the vehicle for example.

FIG. 1(c) shows a modified embodiment of the strap 10 having an end loop 19 configured for the base 12 at one end and a thumb tab 21 at the other end thereof. The thumb tab 21 is a small section of loop fastener 18 or hook fastener 16 material attached to one end of the strap 10 perpendicular to the length of the strap 10. This embodiment is a small bundling strap where an operator can use the thumb tab 21 to hold the strap down during winding around a bundle. The end loop 19 is used to help an operator hold that end while tensioning,

An end loop 19 can also be provided for longer straps for quick attachment to a structure. The strap can be passed back through the end loop 19 around a rail of a trailer for example for quick securing to the trailer. A second end loop can be provided at the other end for the operator to pull on and tension with prior to overlapping and fixing

The loop 19 thus provides a point of attachment for the strap 10 in use. This embodiment can be a more robust version of the strap 10 for use as a heavy duty tie down strap. The end loop 19 can be used as an attachment on one side of a vehicle (looped under the tie bar and attached back onto itself) and then the other side being pulled down tight, pulled under the tie bar and stuck back onto itself via the hook and loop sections 16 and 18. This would be particularly suitable for loads of branches etc. where a tie down is needed, but the owner lacks the rope skills to securely tie the load with rope. This version would also be particularly suited to fixing of a water craft (surf board or the like) to roof racks, where the owner does not want to risk damaging the item or the vehicle with metal hooks, or high tension webbing or the like.

FIG. 5 for example shows tying down of various items 100 to a trailer 110 via the straps 10. The end loop 19 is used to attach to the trailer 110 and the other end of the straps 10 are looped back to attach to another section of the strap 10. Alternatively, the straps 10 can be crossed and attached to each other.

In another application, the strap 10 is used as a fast tie-down or bundling strap. For example, for quickly fixing plastic pipe or similar to the roof rack or trailer of a trade vehicle, replacing the current known methods of using bungee rope, duct tape, electrical tape or similar.

In another version of the product, an end of the strap can have attached to it a brightly coloured flag, such as a triangular flag at one end hanging down in use, such that when the strap is wound around a load of pipe or similar protruding from the back of a vehicle, the load is not only bundled tight, but the flag is seen as a warning to other vehicle users of the overhanging load. Load flags are currently available for sale at plumbing shops and the like, but usually have no useful attaching device with them, so are then often taped to the end of the load requiring more time and effort.

The present invention addresses the problem of tying down small lightweight items which are difficult to tie down with a length of rope as they can be damaged or, if using traditional bungee cords, require multiple turns of the cord which increases the potential of damage (scratching) of the vehicle roof or injury to the operator due to the tensioned metal hook flying through the air during use.

One embodiment of the strap 10 can be a length 60 cm long to allow for a couple of loops around the item being secured, the left-over unused portion can be left hanging or tucked under the roof rack without fear of damage to the vehicle.

The present strap 10 being wider than usual bungee cords provides more surface area coverage to the load, preventing load damage and increasing applied holding down force to the load.

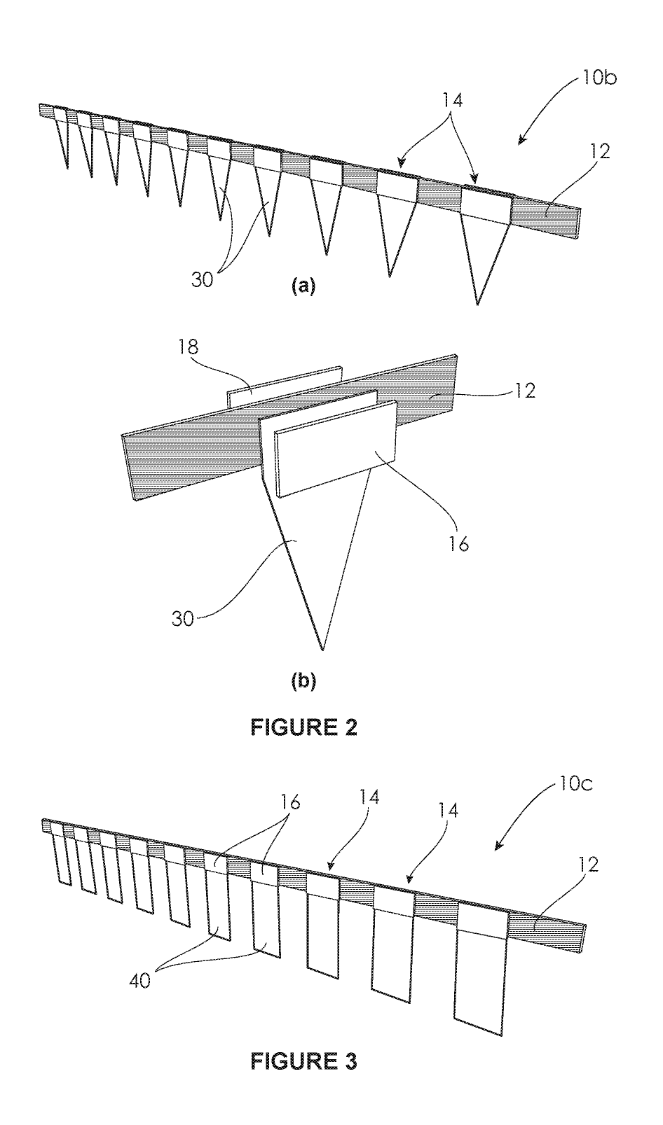

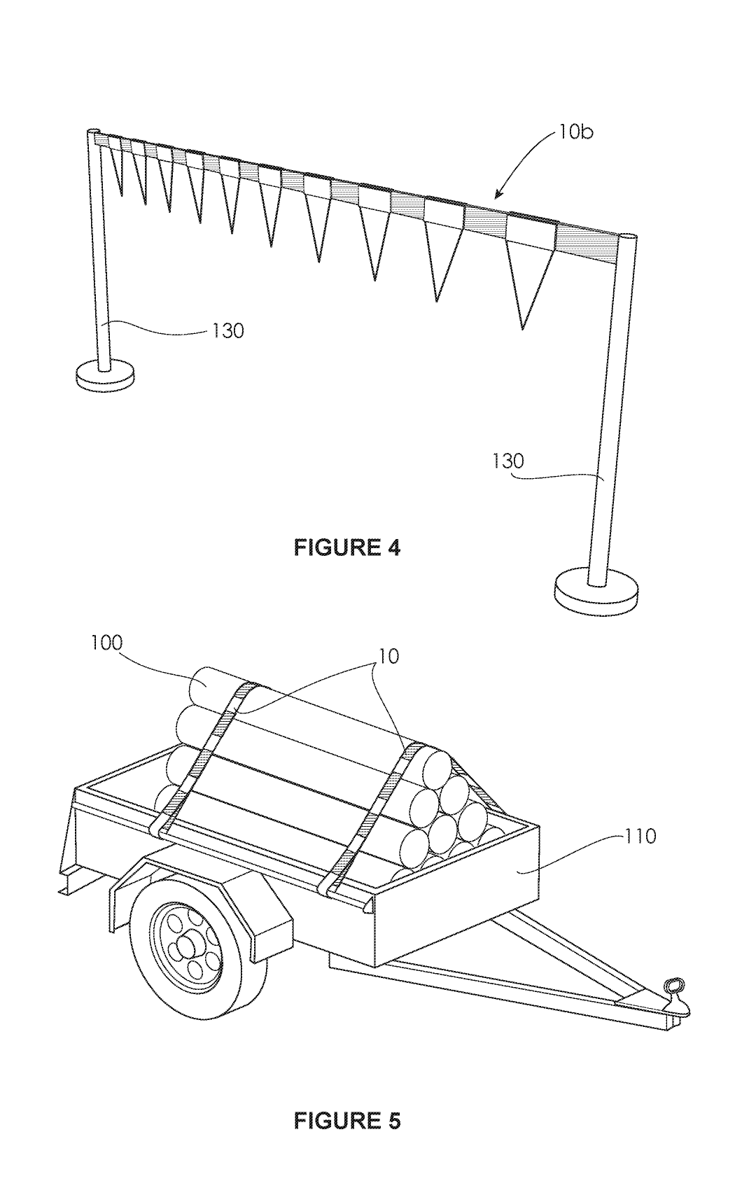

FIGS. 2 and 3 show alternative embodiments 10b and 10c of the present invention strap, which includes a flag 30 or banner 40 of fabric or plastics material fixed between one of the first fastener element 16 or the second fastener element 18, and the central extendable base member 12. These embodiments provide a further use of the invention as a barrier tape, advertising banner, warning strap, etc. FIG. 4 for example shows use of the strap 10b as a barrier tape fixed between two poles 130.

The barricade tape can be used for any number of applications including crowd control, warning, barricading off equipment under service (pedestrian escalators for example), or traffic management.

The flags 30 or banners 40 can be brightly coloured, and a length of several meters of such strap 10b or 10c would be lightweight and easy to transport to a work site. Due to the fact that such a strap 10b or 10c can be wrapped around a post onto itself, the product could be quickly and easily tied off around existing infrastructure (gate posts, rails, balustrading, etc.) or around portable posts taken to the site such as shown in FIG. 4.

For extra effect, the centre section base 12 as well as the hook and loop sections 16 and 18 and flags 30/40 could all be coloured florescent yellow, orange or the like.

The present invention differs from other products by providing a separate inner base of elastic material onto which the paired fastener sections are fixed at pre-determined intervals.

The separation of the extendable base member from the hook and loop fastening members provides the benefit of being able to be made in numerous variations of product based on different elastic materials, such as rubber/neoprene/etc., and or cross sections as well as altering of the spacing and length of the hook and loop sections 14 to provide more or less stretch and gripping area per unit length.

Another benefit of separating the extendable base member is that in a further version of the product the central extendable base member may be printed with words, logos, or the like prior to application of the hook and loop sections 14, in order to convey a warning or advertisement or some such information.

The preferred embodiments provide the following advantages:
a. An extendable self-tensioning strap with extendable inner base onto which fastening elements are fitted at intervals along its length
b. Fastening elements can be hook and loop type, magnetic, or any other intermeshing repositionable fastener
c. Fastening elements are on opposite sides such that the action or wrapping the product around an item or bundle of items secures the strap to itself during the tensioning operation
d. The separation of the extendable inner core of the product from the fastening elements allows the inner core and fastening elements to be configured in a multitude or ways to improve the product performance for particular applications
e. The extendable inner core can be made of a solid extendable material such as woven elastic, rubber or neoprene or conceivably a bundle or smaller elastic elements wound or bundled together
f. The extendable inner core and fastening elements can be coloured such that the colours represent known or warning signs or colours of sporting teams or the like
g. A flag or similar device made from material or thin plastic or the like, can be attached to the extendable inner core under the hook and loop fastening elements creating a length of strap suitable for barricading
h. A flag or similar device made from material or thin plastic or the like could be attached to one end of a length or this strapping to act as a warning flag, suitable for attachment to overhanging loads from vehicles, trailers or the like
i. Hook-less strapping device, being inherently safer than one with any metal or plastic attachments
j. A small section of loop or hook material can be attached to one end of the strap perpendicular to the length of the strap to act as a holding mechanism to retain the strap end during a bundling operation
k. A loop of material can be attached to one end of the strap to act as a finger loop for pulling the strap tight during bundling or tie down operations
l. The multi-use, self-tensioning strap is a device with a variety of uses including:
   i. Strapping goods together (bundling), typically items such as timber, pipe, conduit etc.
   ii. Use as a tie-down strap for attaching goods to a vehicle or trailer to prevent movement during transport
   iii. Used in place of duct tape to secure lighter single articles to roof racks and the like
   iv. Use in place of any bungee cord, while retaining a higher level of safety due to it having no metal components, hooks or buckles
   v. Use as a barricade tape—with the inclusion of warning flags or other bunting intermittently fixed along the length
   vi. Use in place of existing load warning flags typically used by plumbers/tradesmen

Whilst preferred embodiments of the present invention have been described, it will be apparent to skilled persons that modifications can be made to the embodiments described. For example, the paired attachment sections 14 can be spaced unevenly along the length of the base 12. Gaps where not paired attachment sections 14 for example can be provided in the base 12 to increase stretchability along that section if needed.

Also, the paired attachment sections 14 can have alternating hook and loop patches on each side thereof. This can increase the attachment strength or flexibility of use of the strap 10.

1. A strap, comprising:
an elongate resilient base; and
a plurality of spaced paired attachment sections mounted along the base, each paired attachment section comprising first and second fastener elements attachable to each other,
wherein the first fastener element of one attachment section is attachable to the second fastener element in another attachment section.

2. The strap of claim 1, wherein the first and second fastener elements are mounted to the base to face away from each other, and wherein the first and second fastener elements are mounted on opposite sides of the base.

3. The strap of claim 2 wherein the first fastener elements comprise patches of hook fasteners and the second fastener elements comprise patches of loop fasteners.

4. The strap of claim 3, wherein the patches of hook fasteners are mounted spaced along one side of the base and wherein the patches of loop fasteners are mounted spaced along the opposite side of the base.

5. The strap of claim 3 wherein the patches of hook and loop fasteners are alternatingly mounted spaced along each side of the base.

6. The strap of claim 1, wherein the base is comprised of stretchable elastic material.

7. The strap of claim 1 wherein the base is formed as an elongated band.

8. The strap of claim 1 wherein the base is formed as an elastic cord.

9. The strap of claim 1 wherein the paired attachment sections are spaced evenly along the length of the base.

10. The strap of claim 1 wherein the strap comprises an end loop at one end thereof.

11. The strap of claim 10 wherein the strap comprises a thumb tab at the other end thereof extending perpendicularly to the base.

12. The strap of claim 1 wherein the strap comprises an end loop at both ends thereof.

13. The strap of claim 1 wherein the strap comprises a flag at one end thereof.

14. The strap of claim 1, wherein each paired attachment section comprises a flag fixed between one of the first and second fastener elements and the base member.

15. The strap of claim 1 wherein the first and second fastener elements are comprised of one of group consisting of magnetic pairs and intermeshing repositionable fasteners.

16. The strap of claim 11 wherein the thumb tab comprises the first fastener element or the second fastener element.
